(19) United States
(12) Patent Application Publication
(10) Pub. No.: US 2026/0320363 A1
(43) Pub. Date: Oct. 15, 2026

(54) SYSTEMS AND METHODS FOR DIFFERENTIAL REPRESENTATION LEARNING IN NEURAL NETWORKS

(71) Applicant: IRIDA LABS S.A., Patras (GR)

(72) Inventor: Nikos FRAGOULIS, Patras (GR)

(21) Appl. No.: 19/544,463

(22) Filed: Feb. 19, 2026

Related U.S. Application Data
(60) Provisional application No. 63/788,389, filed on Apr. 14, 2025.

(51) Int. Cl. G06N 3/0499

(52) U.S. Cl. CPC G06N 3/0499

(57) ABSTRACT

One exemplary aspect pertains to the field of deep learning, and more specifically, to the representation and modeling of differences between structured data inputs using neural networks. It introduces methods and systems for differential information representation, in which each data point—such as an image, a temporal signal, a sensory reading, or the like—is mapped to a structured latent manifold in a high-dimensional feature space via a neural encoder.

### RELATED APPLICATION DATA

This application claims the benefit of and priority under 35 U.S.C. § 119(e) to U.S. Patent Application No. 63/788,389 filed Apr. 14, 2025, entitled “SYSTEMS AND METHODS FOR DIFFERENTIAL REPRESENTATION LEARNING IN NEURAL NETWORKS,” which is incorporated herein by reference in its entirety.

### BACKGROUND

### Field

One exemplary aspect pertains to the field of deep learning, and more specifically, to the representation and modeling of differences between structured data inputs using neural networks. It introduces methods and systems for differential information representation, in which each data point—such as an image, a temporal signal, a sensory reading, or the like—is mapped to a structured latent manifold in a high-dimensional feature space via a neural encoder.

Unlike traditional vector-based embeddings, this manifold-based formulation preserves both local spatial coherence and semantic context, allowing for a rich representation of structure. One exemplary aspect further comprises a novel Differential Neural Network (DNN) architecture that computes, refines, and propagates difference information progressively across multiple network layers, using trainable difference operators applied at each stage of the network's depth.

The methods proposed are at least applicable to visual, temporal, and multimodal data sources, and can be used in classification, regression, analogical reasoning, domain translation, and other applications where capturing how two data points differ—rather than simply what they are—is one goal.

### Description of Related Art

In conventional machine learning pipelines, particularly those relying on convolutional neural networks (CNNs) or transformer-based encoders, comparing two data inputs typically involves encoding each input into a global latent vector and then applying a fixed distance metric—such as L1 norm, L2 norm, or cosine similarity—to quantify their dissimilarity. This approach, widely used in Siamese networks, contrastive learning, and metric learning frameworks, is effective for tasks like facial verification, image retrieval, and few-shot classification.

However, this dominant paradigm suffers from several critical limitations:
1. It compresses each input into a single latent point, discarding rich spatial structure, localized features, and hierarchical semantics inherent in the original data.
2. The difference function is fixed and non-adaptive (e.g., static subtraction), and therefore cannot capture domain-specific or progressive transformations, such as ripening in fruit, corrosion in materials, or pathological changes in medical imaging.
3. Differences are computed only at the final stage of the network, limiting the network's capacity to learn and refine meaningful distinctions across different levels of abstraction.

Recent developments in manifold learning and geometric deep learning have recognized that data should often be treated not as isolated points in Euclidean space, but as elements on nonlinear, structured manifolds. However, existing methods rarely represent individual data samples as discrete latent manifolds within a learned feature space, and they lack mechanisms to compute progressive, layer-wise difference representations between such manifolds.

Some prior efforts have explored related ideas. For example, the Bipartite Differential Neural Network (BDNN) [1] introduces a dual-stream architecture with a differencing module to isolate changes in unsupervised image pairs, particularly for change detection in remote sensing. However, BDNN is tailored to binary detection and lacks general-purpose support for regression, generation, or multimodal supervision.

Other approaches, such as Semantic Jitter [2], synthesize training data with subtle variations in attributes (e.g., degree of smile or age) to train networks that rank differences between images. While they represent early steps toward learned differential embeddings, these models typically operate on single semantic axes and do not support hierarchical or spatially structured difference learning.

In perceptual similarity modeling, metrics like LPIPS [3] and PieAPP [4] leverage differences in deep features from pretrained networks to quantify visual dissimilarity as perceived by humans. These methods learn scalar distance functions over feature space, but do not provide a structured or progressive mechanism for understanding how two images differ.

Furthermore, change captioning architectures such as DUDA [5] use dual attention mechanisms to generate natural language descriptions of differences between image pairs. Although these systems model internal difference representations, they are purpose-built for captioning and lack generality for other tasks like classification or physical regression.

One exemplary aspect advances beyond these methods by introducing a new architectural paradigm: the Differential Neural Network (DNN). In this exemplary system:
Each input is represented as a discrete latent manifold in a high-dimensional space;
Differences are computed using learnable, task-adaptive operators embedded at each network layer;
The network learns a hierarchical differential representation, progressively capturing differences from low-level texture to high-level semantics.

This approach generalizes across domains and tasks—enabling classification, regression, and transformation modeling—while supporting multimodal supervision from physical or biochemical sensors. It overcomes the limitations of fixed metric comparison by evolving a semantically rich notion of difference, learned jointly with the data and the task.

### SUMMARY

One exemplary aspect provides a new system and method for learning and representing the differences between pairs of structured data inputs using a novel deep learning architecture referred to as a Differential Neural Network (DNN). In contrast to traditional methods that treat inputs as global vectors and apply static distance functions, the technique introduces the notion of learned manifold-based difference representations, where each input is encoded as a discrete latent manifold in a high-dimensional feature space.

The core components of the exemplary technique include:
A dual-stream or multi-stream neural architecture, where each input is independently processed into a latent manifold through convolutional or neural layers;
A learned differential operator that computes a local, structured, and task-specific transformation between two manifolds, operating progressively at each layer of the network;
A series of Cross-Fusion Modules, which propagate and refine partial differences across network depth, enabling the system to learn a rich, hierarchical encoding of differences—from low-level spatial changes to high-level semantic shifts;
Output modules that use the final difference embedding to perform a chosen task, such as classification (e.g., change detection), regression (e.g., predicting physical parameters like pH or sweetness), or generative transformation (e.g., applying the learned difference to synthesize new states).

One exemplary aspect further supports multimodal supervision, allowing training on data where the ground truth differences are derived from non-visual sensors or physical measurements. This enables practical deployment in a wide range of domains, such as fruit maturation monitoring, medical diagnosis, precision agriculture, materials aging, and industrial inspection, and the like.

By modeling differences as learned, structured transformations between manifolds, the technique provides a flexible, extensible, and semantically powerful alternative to fixed metric comparison schemes.

### BRIEF DESCRIPTION OF THE DRAWINGS

FIG. 1 is a schematic illustrating how an image is mapped to a feature-map manifold in a high-dimensional latent space, showing discretized local embeddings.

FIG. 2 depicts a dual-stream differential neural network architecture with cross-fusion modules at multiple layers (representing the progressive difference propagation).

FIG. 3 depicts the architecture of a Cross-Fusion Module

### DETAILED DESCRIPTION

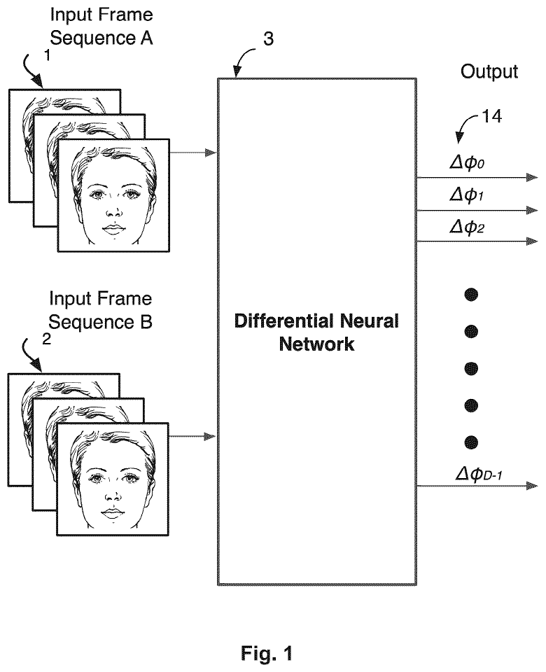

To illustrate the core operational flow of an exemplary aspect, FIG. 1 presents a high-level schematic of the exemplary processing pipeline involving two input data sequences and their differential analysis by the proposed Differential Neural Network (DNN) architecture.

The figure depicts two input streams, labeled Input Frame Sequence A (1 in FIG. 1) and Input Frame Sequence B (2 in FIG. 1), each comprising a temporally ordered set of visual data frames. These frames may correspond, for example, to different time points in a video, different imaging modalities, or sensor captures from distinct measurement contexts. While the schematic illustrates human face images for visualization clarity, the technique is not limited to facial inputs or video streams. The architecture is general and can process any structured input domain, including images, audio spectrograms, multi-channel sensor data, abstract token embeddings, or the like.

Each sequence is independently fed into the respective input channels of the Differential Neural Network module (3 in FIG. 1). Internally, this module processes both streams through layered encoders and progressive cross-fusion modules, as described in earlier sections. At each layer, the network computes a structured difference representation, which evolves hierarchically across depth. These differences capture transformations at multiple abstraction levels-ranging from low-level spatial changes to high-level semantic or physical state shifts.

The outputs of the DNN are denoted collectively as Δφ₀, Δφ₁, Δφ₂, . . . , Δφ_{D-1} indicated at the right-hand side of the schematic as Output (4 in FIG. 1). Each Api represents a differential embedding or task-relevant transformation computed at a specific depth i of the network. These may be used individually or aggregated, depending on the application.

In some configurations, the outputs Δφᵢ are used for downstream tasks such as:
Classification of change type (e.g., healthy vs. infected crop),
Regression of physical state deltas (e.g., ΔBrix, Δmoisture),
Or generative transformation (e.g., predicting the expected future appearance of the object under observation).

This architecture supports training with supervised, weakly-supervised, or multimodal supervision, and may operate in real-time or batch mode.

### 1. Mathematical Formulation of Differential Information

To develop a mathematical framework for this method, we begin by formally defining the space of data, the embedding process, and the nature of the differential operator that maps differences in a learnable way.

Let us denote by

[symbol]

⊂ [symbol] ^{H×W×C} (1)

the space of raw input data (e.g., RGB images of height H, width W, and C channels). Let x⁽¹⁾, x⁽²⁾∈ [symbol] represent two such inputs, whose relationship we wish to model.

We define a convolutional encoder φ: [symbol] → [symbol] ^{h×w×d} where φ(x)=M∈ [symbol] ^{h×w×d}, maps an input into a structured feature tensor (also interpreted as a discrete manifold in latent space). Each spatial coordinate (i, j) in the feature tensor corresponds to a feature vector M_{i,j}∈ [symbol] ^{d}, encoding local and global semantics.

Thus, the two inputs are mapped as:

M⁽¹⁾=φ(x⁽¹⁾),M⁽²⁾=φ(x⁽²⁾) (2)

We then define a differential operator:

Δ_{θ}: [symbol] ^{h×w×d}× [symbol] ^{h×w×d}→ [symbol] ^{h×w×d}, (3)

where θ are learnable parameters, and Δ_{θ}: [symbol] ^{h×w×d}× [symbol] ^{h×w×d}→ [symbol] ^{h×w×d}, is a learned difference tensor. Unlike static subtraction M⁽²⁾−M⁽¹⁾ this operator may involve attention, gating, learned alignment, or nonlinear fusion, as parameterized by θ.

Moreover, we interpret the tensors M⁽²⁾ as discrete approximations of smooth manifolds embedded in a higher-dimensional space [symbol] ⊂ [symbol] ^{d}. Under this interpretation, each local feature vector can be seen as a point on a Riemannian manifold, and the difference tensor is a tangent vector field:

Δ_{θ}(M⁽¹⁾,M⁽²⁾∈T_{M}_{⁽¹⁾} [symbol] , (4)

i.e., in the tangent space at manifold M⁽¹⁾. This is consistent with the logarithmic map log_{M}_{⁽¹⁾}(M⁽²⁾) in differential geometry, which gives a tangent vector pointing from one manifold to another along a geodesic.

This framework enables us to express differences not only in Euclidean terms but also as intrinsic displacements on a learned geometric structure. For example, color or style transitions (e.g., summer to winter), cooking transformations (e.g., raw to grilled), or changes in shape or pose are modeled as semantically meaningful vector fields in the latent manifold space.

We emphasize that this operator is progressive, in the sense that it is applied at each layer of the network, leading to an evolving set of difference maps:

$${Δ}_{θ}^{( l )} = {Δ}_{θ}^{( l )} ( {M}_{l}^{( 1 )} , {M}_{l}^{( 2 )} ) , l = 1 , … , L , \qquad ( 5 )$$

Where L is the number of layers, and

$${M}_{l}^{( 2 )} {M}_{l}^{( 2 )}$$

are the feature maps at layer l. This evolution allows the network to move from low-level differences (edges, textures) to high-level differences (objects, semantics) in a hierarchical and interpretable manner.

In FIG. 1, this concept is illustrated by mapping an image into a latent manifold, where each location (i, j) in the output tensor corresponds to a point on the manifold. These discrete points collectively form a structured surface embedded in high-dimensional space. This is a key departure from traditional vector embeddings, where an image is compressed into a single, global descriptor.

### 2. Differential Neural Network Architecture

To operationalize the concept of progressive, manifold-based difference representation, we introduce a novel architecture called the Differential Neural Network (DNN). This architecture is designed from the ground up to not only encode two input data points but also to compute, refine, and propagate their differences as structured feature maps through the depth of the network.

The design is based on a dual-stream architecture, wherein each input is processed by a separate but architecturally identical pipeline—also referred to as a branch. The distinguishing characteristic of this design is the explicit modeling and propagation of differences at every layer. These differences are computed using trainable modules, inserted after each stage, which estimate differential information from the latent representations of the two branches.

### 2.1 Dual-Stream Encoding of Inputs

Let x⁽¹⁾, x⁽²⁾∈ [symbol] be two input images or data points, representing two different states or instances of an entity (e.g., raw vs. cooked food, or a scene at different times).

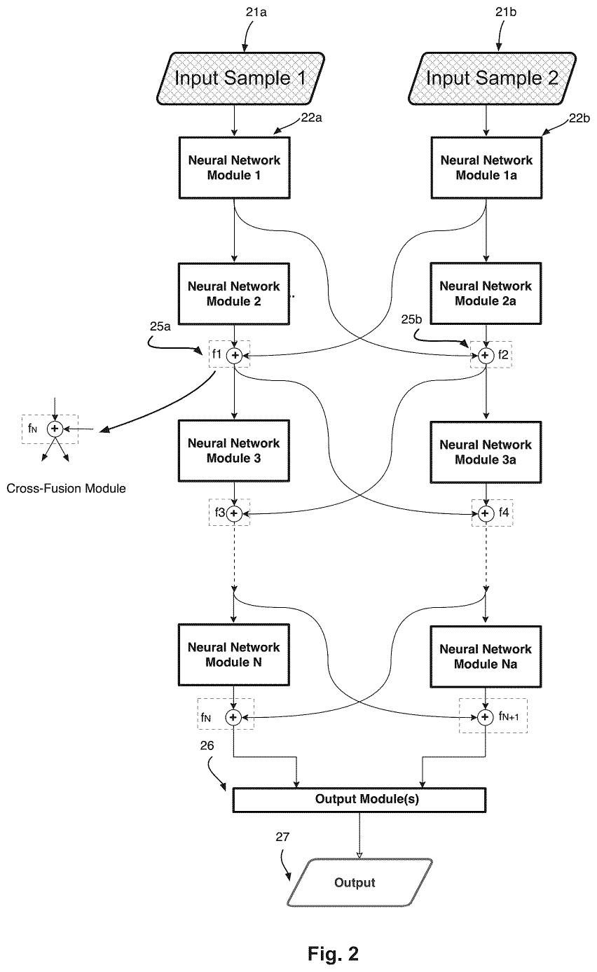

Each of these inputs is passed through its own processing stream. The two streams are referred to as Branch A and Branch B, as denoted in elements (21a) and (21b) of FIG. 2 respectively.

Each branch processes its input using a stack of neural network Modules (22a and 22b in FIG. 2), which may include:
Convolutional blocks
Residual connections
Normalization layers
Non-linear activations (e.g., ReLU)

Let us define the sequence of learned transformations in branch A by:

$${M}_{l}^{( 1 )} = {f}_{l}^{( 1 )} ( {M}_{l - 1}^{( 1 )} ) , l = 1 , 2 , … , L , \qquad ( 6 )$$

with

$${M}_{0}^{( 1 )} = {x}^{( 1 )}$$

and similarly for branch B:

$${M}_{l}^{( 2 )} = {f}_{l}^{( 2 )} ( {M}_{l - 1}^{( 2 )} ) , {M}_{0}^{( 2 )} = {x}^{( 2 )} . \qquad ( 7 )$$

The outputs

$${M}_{l}^{( 1 )} ∈ {\text{?}}^{{h}_{l} \times {w}_{l} \times {d}_{l}}$$

and

$${M}_{l}^{( 2 )} ∈ {\text{?}}^{{h}_{l} \times {w}_{l} \times }$$

at each layer l represent the latent manifold representations of the input at different semantic levels.

### 2.2 Cross-Fusion Modules for Progressive Difference

A key innovation in the proposed Differential Neural Network (DNN) architecture lies in its use of Cross-Fusion Modules (25a and 25b in FIG. 2) to compute differences between input manifolds at each layer of the network. These modules are more than simple difference operators like subtraction or element-wise comparison; they are trainable, non-linear, context-sensitive functions that operate on high-dimensional structured data, i.e., feature maps or latent manifolds.

After each layer l, the network does not proceed independently for each input. Instead, the corresponding latent manifolds

$${M}_{l}^{( 1 )}$$

and

$${M}_{l}^{( 2 )}$$

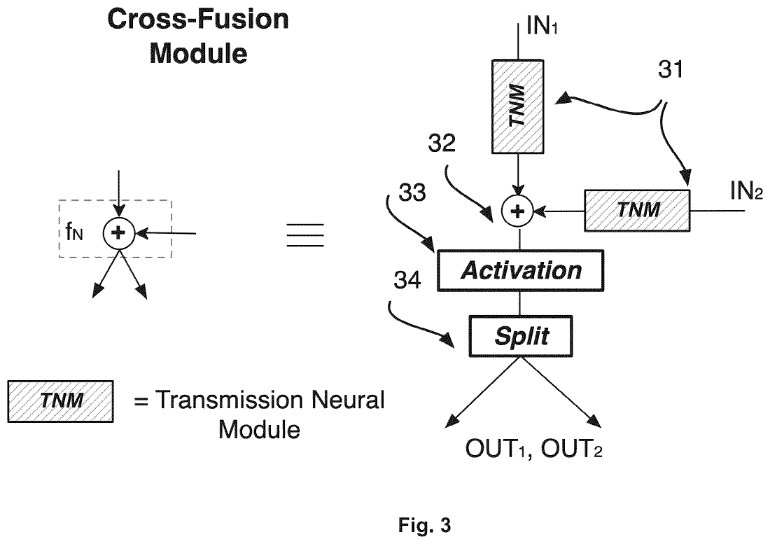

are passed into a Cross-Fusion Module, denoted as element (25a and 25b) in FIG. 2 and elaborated in FIG. 3.

This module implements a learned difference operator:

$${Δ}_{θ}^{( l )} = {𝒟}^{( l )} ( {M}_{l}^{( 1 )} , {M}_{l}^{( 2 )} ) , \qquad ( 8 )$$

where [symbol] ^{(l)} is a parametric function defined by a neural subnetwork, and

$${Δ}_{θ}^{( l )} ∈ {\text{?}}^{{h}_{l} \times {w}_{l} \times {d}_{l}}$$

represents the partial difference map at layer l.

In FIG. 3, the internal structure of the Cross-Fusion Module is illustrated. Each input manifold is passed through a transmission module—shown as the pair of blocks (31a) and (31b in FIG. 3)—which may consist of convolutional layers followed by non-linearities (e.g., ReLU and Sigmoid). These intermediate representations are then combined by a combinator module (element 32 in FIG. 3), which could perform learned subtraction, gating, or attention. The result of the fusion operation is passed through an activation unit (33) and then through a splitter (34 in FIG. 3), which replicates the processed information into two streams again—allowing the flow of both the original and differential information into the next layer of each branch.

### Transmission Modules for Lateral Cross-Talk (Blocks 31 in FIG. 3)

At the input of the cross-fusion module, Transmission Modules (elements 31 in FIG. 3) are introduced to allow lateral cross-talk between the two branches. These modules receive feature maps from one branch and inject processed versions of them into the other branch, enhancing the inter-stream information flow.

Mathematically, let

$${T}_{l}^{( 1 \to 2 )}$$

denote the transmission of features from Branch A to Branch B:

$${\hat{M}}_{l}^{( 2 )} = {M}_{l}^{( 2 )} + {𝒯}_{l} ( {M}_{l}^{( 1 )} ) , \qquad ( 9 )$$

where [symbol] ₗ is a compact CNN block (e.g., 1×1 convolutions followed by downsampling) that transforms the features of one stream to be compatible with the other.

This module allows the architecture to share information without symmetry constraints (e.g., unlike strict weight sharing) and contributes to a more nuanced estimation of difference signals by considering the relative transformation contextually.

### Combinator Module (32 in FIG. 3),

A common instantiation of this is:

$${Δ}_{i , j}^{( l )} = σ ( {W}_{1} {M}_{i , j}^{( 1 )} + {W}_{2} {M}_{i , j}^{( 2 )} + b ) , \qquad ( 10 )$$

where W₁, W₂ are learnable weight matrices and o is a non-linear activation function. Other options also exist for this fusion mechanism, each representing a distinct hypothesis about how local differences should be measured:

### Option 1: Learnable Subtraction

$${Δ}_{l} ( i , j ) = {W}_{1} {\hat{M}}_{l}^{( 1 )} ( i , j ) - {W}_{2} {\hat{M}}_{l}^{( 2 )} ( i , j ) , \qquad ( 11 )$$

where W₁, W₂∈ [symbol] ^{d}^{ₗ}^{×d}^{ₗ} are learned matrices that control how each input is scaled or rotated in latent space before subtraction.

### Option 2: Gated Fusion

$${Δ}_{l} ( i , j ) = σ ( G ( {\hat{M}}_{l}^{( 1 )} ( i , j ) , {\hat{M}}_{l}^{( 2 )} ( i , j ) ) ) \cdot ( {\hat{M}}_{l}^{( 2 )} ( i , j ) - {\hat{M}}_{l}^{( 1 )} ( i , j ) ) , \qquad ( 12 )$$

where G is a neural gate (e.g., a small MLP), and σ is a sigmoid function controlling the importance of each local difference.

### Option 3: Self-Attention-Based Fusion

Define keys K, queries Q, and values V from both inputs and compute:

$${Δ}_{l} = Attention ( Q , K , V ) = soft max ( \frac{{QK}^{T}}{\sqrt{d}} ) V , \qquad ( 13 )$$

where attention weights encode correspondence or alignment between features at different locations.

The result is a high-dimensional difference map, where each spatial location encodes how the corresponding regions of the two inputs differ in a learned, nonlinear, and often asymmetric way

The result of the fusion operation is passed through a ReLU activation unit (33) and then through a splitter (34), which replicates the processed information into two streams again-allowing the flow of both the original and differential information into the next layer of each branch.

### Activation and Post-Fusion Processing (33 in FIG. 3)

The result of the combinator is passed through an activation block, most commonly a ReLU or a leaky ReLU, as shown in element (33):

Δ^{(l)}(i,j)=ReLU(Δₗ(i,j)), (14)

ensuring that negative-valued features are thresholded and that the network focuses on positively activated difference signals, which often correspond to presence, emergence, or semantic intensification. In different embodiments other activation units can also be used such as Tanh etc.

### Splitter for Dual Propagation (Block 34 in FIG. 3)

The final difference tensor is passed through a Splitter Module, indicated as element (34) in FIG. 3. This module creates two copies of the difference embedding:
One is fed back to the next layer of Branch A
The other is passed to the next layer of Branch B

This strategy allows both streams to continue processing their original content, but now informed by a shared and explicit estimate of their difference. This enables each stream to modulate its latent representations based on the discrepancy with the other, a key advantage in tasks where relational or transformational understanding is necessary.

### 2.3 Final Output and Decision Layers

After the final layer L, each branch and the series of difference maps

$${\{ {Δ}^{( l )} \}}_{l = 1}^{L}$$

are passed to output modules, illustrated as elements (26) and (27) in FIG. 2. These may take the form of:
Fully connected layers for classification of difference type
Convolutional regression heads for spatially-varying difference estimation
Generative decoders for image transformation or synthesis

Let y be the desired output (e.g., class label, attribute change vector). The final output is modeled as:

y=g(Δ⁽¹⁾, . . . ,Δ^{(L)}), (15)

where g is a differentiable function composed of downstream layers (e.g., MLPs or decoders). This output may include:
A classification head for categorical difference (e.g., “raw→cooked”, “sunny→cloudy”)
A regression head predicting continuous values (e.g., brightness difference)·
A generative head decoding a transformation from x⁽¹⁾ to a hypothetical \hat{x}⁽²⁾ using the learned difference

This modular design allows the architecture to be easily adapted to various tasks, such as change detection, style transfer, defect recognition, and analogical reasoning.

### 3. Training Framework and Objective Functions

The Differential Neural Network (DNN) architecture is designed to extract and refine difference information across its depth, but its effectiveness relies critically on how it is trained. This section presents a formal treatment of the training methodology, including the supervised and optional unsupervised loss functions that drive learning. We emphasize that the architecture allows for multiple output heads—each potentially associated with different objectives—enabling the network to be flexibly adapted to classification, regression, or generative transformation tasks.

The training process includes five interwoven stages:
1. Data pair generation and preprocessing
2. Forward propagation through the dual-stream DNN
3. Layer-wise difference computation via Cross-Fusion Modules
4. Output generation through dedicated task-specific heads
5. Loss evaluation and parameter update via backpropagation

### 3.1 Dataset and Input Pairing

Training the network requires labeled or semi-labeled pairs of examples (x⁽¹⁾, x⁽²⁾) each representing two states of a system or object.

Let the training dataset be denoted by:

$$𝒟 = {\{ ( {x}_{i}^{( 1 )} , {x}_{i}^{( 2 )} , {y}_{i} ) \}}_{i = 1}^{N} , \qquad ( 16 )$$

where

$${x}_{i}^{( 1 )} , {x}_{i}^{( 2 )} ∈ \text{?} ⊂ {\text{?}}^{H \times W \times C} ,$$

and yᵢ∈y represents the label associated with the difference. This label yᵢ may be:
A discrete class label: for classification tasks (e.g., “unchanged,” “cooked,” “defective”)
A real-valued vector: for regression tasks (e.g., “Δbrightness,” “Δtemperature,” “Δstructure”)
A target image or latent representation: for generative tasks (e.g., translating x⁽¹⁾ into x⁽²⁾

The network does not require that x⁽¹⁾ and x⁽²⁾ be strictly temporally ordered or evenly spaced. Arbitrary pairings are supported due to the pairwise design of the architecture.

### 4.2 Forward Propagation and Difference Computation

Each input pair is passed through its respective stream, as defined in Section 3:

$${M}_{l}^{( 1 )} = {f}_{l}^{( 1 )} ( {M}_{l - 1}^{( 1 )} ) , {M}_{0}^{( 1 )} = {x}^{( 1 )} , {M}_{l}^{( 2 )} = {f}_{l}^{( 2 )} ( {M}_{l - 1}^{( 2 )} ) , {M}_{0}^{( 2 )} = {x}^{( 2 )} , \qquad ( 17 )$$

After each layer, the Cross-Fusion Module computes the partial difference Δₗ as previously defined:

$${Δ}_{l} = {𝒟}_{θ}^{( l )} ( {M}_{l}^{( 1 )} , {M}_{l}^{( 2 )} ) , for l = 1 , … , L . \qquad ( 18 )$$

These intermediate difference embeddings are progressively refined through the network.

At the final layer L, the set of difference representations {Δ₁, . . . , Δ_{L}} are aggregated—either by concatenation, attention pooling, or feature fusion—into a final difference encoding Δ* which is passed to a task-specific output module.

### 3.3 Output Modules and Target Prediction

The final differential encoding Δ* is processed by an output module ŷ=ψ(Δ*; γ), designed for the task at hand:

\hat{y}=ψ(Δ*;γ), (19)

where γ are learnable weights of the output head.

Depending on the application, ψ may represent:
A classification head: a linear layer followed by softmax
A regression head: one or more fully-connected layers with linear or bounded output
A decoder head: for reconstructing or transforming one input to another, possibly using transposed convolutions or learned upsampling layers

### 3.4 Loss Functions

The total training loss is composed of one or more objectives, reflecting the nature of the problem domain.

Supervised Task Loss [symbol] ₜₐₛₖ

This loss measures how accurately the network predicts the true difference label ŷ based on ŷ It is directly derived from the data and is always present during supervised training.

### For Classification:

$${ℒ}_{task} = - {\sum }_{c = 1}^{C} {y}_{c} log {\hat{y}}_{c} \qquad ( 20 )$$

where C is the number of classes and y_{c} is the one-hot ground truth.

### For Regression:

$${ℒ}_{task} = {‖ \hat{y} - y ‖}_{2}^{2} , \qquad ( 21 )$$

possibly augmented with weighting for multi-output regression.

### For Generative Reconstruction:

$${ℒ}_{task} = {‖ ψ ( {Δ}^{*} ) - {x}^{( 2 )} ‖}_{1} + {λ}_{perceptual} \cdot {‖ Φ ( ψ ( {Δ}^{*} ) ) - Φ ( {x}^{( 2 )} ) ‖}_{2}^{2} , \qquad ( 22 )$$

where Φ is a pre-trained perceptual feature extractor (e.g., VGG).
Consistency Loss [symbol] _{cons}

When available, additional training pairs with the same transformation label (e.g., two examples of “raw→cooked”) can be used to enforce internal consistency:

$${ℒ}_{cons} = {‖ {Δ}^{*} ( {x}_{i}^{( 1 )} , {x}_{i}^{( 2 )} ) - {Δ}^{*} ( {x}_{j}^{( 1 )} , {x}_{j}^{( 2 )} ) ‖}_{2}^{2} , \qquad ( 23 )$$

encouraging the network to learn canonical differential encodings for repeated transformation types.

This loss introduces a notion of intra-class differential alignment and is especially helpful when dealing with analogical or relational learning tasks.

Optional Generative or Adversarial Loss [symbol] _{adv}

In tasks where the network is used to transform one input into another (e.g., stylization, domain adaptation), an adversarial loss may be added to encourage visual fidelity and distribution matching:

[symbol]

_{adv}= [symbol] [log D(x⁽²⁾]+ [symbol] [log(1−D(\hat{x}⁽²⁾))], (24)

where D is a discriminator network, and \hat{x}⁽²⁾=ψ(Δ*)

The final training loss is thus:

[symbol]

ₜₒₜₐₗ= [symbol] ₜₐₛₖ+λ_{cons} [symbol] _{cons}+λ_{adv} [symbol] _{adv}, (25)

with task-specific weights λ_{cons}, λ_{adv}∈ [symbol] _{≥0}.

### 3.5 Optimization and Backpropagation

All parameters in the network—including those in the feature extractors, transmission modules, cross-fusion blocks, and output heads—are updated via stochastic gradient descent or any compatible optimizer such as Adam or RMSProp. Because the difference computation at each layer is fully differentiable and parameterized, the network learns not only what features to extract, but also how to represent the transformation between inputs.

### 3.6 Generalization and Pair Sampling Strategy

The pairwise design of the DNN allows for flexible sampling during training. In particular, the following pairing strategies can be employed:
Exhaustive pairing: Use all combinations (xᵢ, xⱼ) from the same object or class.
Temporal pairing: Sample (xₜ, x_{t+δ}) across time for sequential datasets.
Semantic analogy pairing: Enforce relational structure by sampling analogical quadruples.

Moreover, bi-directional training (using both x⁽¹⁾→x⁽²⁾x⁽²⁾→x⁽¹⁾ may be employed to improve stability and regularization, especially when difference directions are invertible

4. Application: Fruit Maturation Monitoring with Multimodal Labels

The theoretical foundation and architectural design of the Differential Neural Network (DNN) outlined in previous sections are sufficiently general to support a wide variety of use cases that involve tracking transformations between pairs of input signals. Although the architecture was initially conceptualized with visual data in mind, its structure naturally accommodates multimodal supervision, including external measurements derived from physical, biochemical, or environmental sensors.

In this section, we present a novel and practically relevant use case: monitoring the maturation of fruits using visual data paired with non-visual biochemical measurements such as pH level, sugar concentration (Brix value), moisture content, and salinity. This application demonstrates the utility and concrete application of the proposed architecture in domains that require cross-modal reasoning, semantic difference understanding, and predictive regression of physically meaningful variables.

### 4.1 Problem Formulation and Dataset Structure

Let us denote by x⁽¹⁾∈ [symbol] the image of a fruit at an initial stage of maturation (e.g., unripe), and by x⁽²⁾∈ [symbol] the image of the same fruit at a later stage (e.g., semi-ripe or ripe). These images are captured and stored (in appropriate memory/storage) under standardized lighting and camera setup, or augmented to simulate real-world variability.

For each such pair, we associate a real-valued difference vector y∈ [symbol] ^{m} corresponding to the measured biochemical differences obtained from specialized sensors or laboratory instrumentation. Specifically, we define:

y=[ΔpH,ΔBrix,Δmoisture,Δsalinity]^{T} (26)

where each entry quantifies the change in a biochemical property of interest between time t₁ and t₂.

The dataset is thus structured as:

$$𝒟 = {\{ ( {x}_{i}^{( 1 )} , {x}_{i}^{( 2 )} , {y}_{i} ) \}}_{i = 1}^{N} , \qquad ( 27 )$$

where each example provides a pair of visual manifolds and a corresponding transformation vector in physical space.

### 4.2 Network Operation and Regression Target

As in previous sections, the input pair is passed through the dual-stream Differential Neural Network. For each image, the encoder produces a sequence of feature manifolds:

$${M}_{l}^{( 1 )} = {f}_{l}^{( 1 )} ( {x}^{( 1 )} ) , {M}_{l}^{( 2 )} = {f}_{l}^{( 2 )} ( {x}^{( 2 )} ) , l = 1 , … , L , \qquad ( 28 )$$

which are treated as discrete manifolds embedded in [symbol] ^{h}^{ₗ}^{×w}^{ₗ}^{×d}^{ₗ}. The Cross-Fusion Modules compute partial differences at each layer:

$${Δ}_{l} = {𝒟}_{θ}^{( l )} ( {M}_{l}^{( 1 )} , {M}_{l}^{( 2 )} ) , \qquad ( 29 )$$

These layer-wise differential embeddings are aggregated into a final representation:

$${Δ}_{l} = {𝒟}_{θ}^{( l )} ( {M}_{l}^{( 1 )} , {M}_{l}^{( 2 )} ) , \qquad ( 30 )$$

where [symbol] is an aggregation operator, such as concatenation followed by attention pooling or global average pooling.

The output module is a multi-head regressor:

ŷ=ψ(Δ*;γ), (31)

with ŷ∈ [symbol] ^{m} approximating the true measured differences. Each head corresponds to one biochemical attribute and is trained jointly with the others, allowing shared latent features across prediction targets.

### 4.3 Loss Function and Optimization Objective

The primary loss function in this scenario is a multi-output regression loss:

$${ℒ}_{reg} = \frac{1}{m} {\sum }_{j = 1}^{m} {{λ}_{j} ( {\hat{y}}_{j} - {y}_{j} )}^{2} \qquad ( 32 )$$

where λⱼ is a task-specific scaling factor to normalize or prioritize particular dimensions (e.g., emphasize Brix over moisture).

Optionally, consistency regularization may be applied if examples of repeated transformations (e.g., different apples ripening under similar conditions) are available:

$${ℒ}_{cons} = {‖ {Δ}_{i}^{*} - {Δ}_{j}^{*} ‖}_{2}^{2} for {y}_{i} \approx {y}_{j} \qquad ( 33 )$$

The total loss becomes:

[symbol]

ₜₒₜₐₗ= [symbol] _{reg}+λ_{cons}· [symbol] _{cons} (34)

and is minimized using backpropagation with a suitable optimizer (e.g., Adam).

### 4.4 Interpretation and Deployment

Once trained, the DNN can be deployed in a production environment where only visual input is available (e.g., field camera or quality control station). The network is capable of inferring:
Δ sweetness from surface gloss and color hue
Δ pH from subtle visual cues such as bruising, spot development, or color shift
Δ moisture from texture appearance and light reflectivity
Δ salinity from rind deformation or density-related traits (if visually relevant)

This allows non-invasive estimation and output of otherwise destructive or labor-intensive measurements, using differential visual reasoning in place of direct sensing.

Such a system could be applied in:
Sorting lines for fruit ripeness and quality
Monitoring fruit maturing in storage or on the tree
Estimating biochemical readiness for harvest or sale
Informing downstream supply chain decisions (e.g., logistics, shelf-life)

### 4.5 Broader Applications: Toward Multimodal Difference Modeling

While the fruit maturation use case exemplifies the power of visual+sensor pairing, the architecture generalizes seamlessly to other domains where differences evolve in high-dimensional, nonlinear, and multimodal ways.

Some examples include:
Precision agriculture: Images of leaves or plants over time, paired with soil nitrate, temperature, or light exposure sensors.
Medical diagnostics: Skin, retinal, or oral cavity images with clinical markers like inflammation, glucose, or hydration.
Material science: Images of metal corrosion or composite aging, with mechanical or chemical tests as supervision.
Industrial inspection: Thermographic or radiographic images over time with stress, viscosity, or component integrity metrics.
Cooking: Images of cooking foods over time with measures such as moisture, crispiness, salinity.

In each case, the DNN enables visual understanding of physical change across domains, by learning the latent structure of difference and its mapping to real-world signals.

The exemplary systems and methods described herein primarily relate to applications that assess and capturing how two data points differ. However, to avoid unnecessarily obscuring the present disclosure, certain well-known structures and devices are omitted from the preceding description. Such omissions should not be interpreted as limitations on the scope of the claims. Specific details provided herein facilitate understanding of the disclosure, yet it should be appreciated that this disclosure may be practiced beyond the explicit details presented.

Furthermore, although the components described herein may be depicted as collocated, certain elements of the system may be remotely located within various portions of distributed networks such as LANs, the Internet, or dedicated systems. Components may be combined into single or multiple devices including personal computers (PCs), laptops, netbooks, smartphones, tablets, cloud computing resources, or other similar devices. Communication links between components may be wired, wireless, or combinations thereof, utilizing electrical signals carried by media such as coaxial cables, copper wires, fiber optics, or even acoustic or light waves.

The flowcharts and methodologies described and illustrated herein should be understood to allow for modifications, additions, or omissions in sequence without materially affecting the functionality of the disclosed embodiments.

It should be noted that the systems and methods described may be implemented using general-purpose or special-purpose computers, microprocessors, microcontrollers, ASICs, DSPs, programmable logic devices, or other hardware or software solutions known in the art. Software implementations may include distributed processing, parallel processing, or virtual machine processing, adaptable to a variety of computer platforms and environments.

While certain processors and standards have been referenced, the disclosure is not limited to these specific examples, as similar or superior processors, standards, and protocols may emerge and are considered within the scope of this disclosure.

Moreover, this disclosure encompasses all aspects, configurations, embodiments, sub-combinations, and subsets thereof, whether or not explicitly depicted and described. The presented discussion is intended solely for illustration and clarity, and should not limit the disclosure to the precise forms disclosed herein. Each claim is intended to represent an independent embodiment of the invention, not necessarily requiring all the features described herein.

### REFERENCES (ALL OF WHICH ARE INCORPORATED HEREIN BY REFERENCE IN THEIR ENTIRETY)

[1] Liu, J., et al. Bipartite Differential Neural Network for Unsupervised Image Change Detection. IEEE TNNLS, 2020.
[2] Yu, A., & Grauman, K. Semantic Jitter: Dense Supervision for Visual Comparisons via Synthetic Images. ICCV 2017.
[3] Zhang, R., et al. The Unreasonable Effectiveness of Deep Features as a Perceptual Metric. CVPR 2018.
[4] Prashnani, E., et al. PieAPP: Perceptual Image-Error Assessment Through Pairwise Preference. CVPR 2018.
[5] Park, J., et al. Robust Change Captioning. ICCV 2019.

1. A method for learning the transformation between two instances of structured input data using a differential neural network, the method comprising:
receiving a first data input and a second data input, both mapped into high-dimensional latent spaces via a shared or separate feature extractor;
representing each input as a discrete latent manifold;
determining a learned difference representation using a series of parameterized Cross-Fusion Modules applied progressively at each layer l, and
using this representation to predict a target output corresponding to a measured or inferred transformation across the two input states.

2. The method of claim 1, wherein:
the first data input is x⁽¹⁾ and the second data input is x⁽²⁾,
the discrete latent manifold is given by: M⁽¹⁾, M⁽²⁾∈ [symbol] ^{h×w×d};
the learned difference representation is given by: Δ*∈ [symbol] ^{h×w×d};
the determining of the learned difference representation uses a series of parameterized Cross-Fusion Modules applied progressively at each layer l, such that:
$${Δ}^{*} = 𝒜 ( {𝒟}_{θ}^{( 1 )} ( {M}_{1}^{( 1 )} , {M}_{1}^{( 2 )} ) , … , {𝒟}_{θ}^{( L )} ( {M}_{L}^{( 1 )} , {M}_{L}^{( 2 )} ) ) ;$$
and
The target output is given by: ŷ∈ [symbol] ^{m}

3. The method of claim 1 wherein the target output y is not derived directly from the inputs, but from external sensors or measurement systems associated with each input pair (x⁽¹⁾, x⁽²⁾) such that:
y=[Δproperty_1,Δproperty_1, . . . ]∈ [symbol] ^{m},
and the network is trained to regress these values from the computed difference tensor Δ*.

4. A neural network architecture comprising two parallel processing streams or branches, each receiving a distinct input x⁽¹⁾ and x⁽²⁾ and wherein:
each stream includes a sequence of neural modules
$$\{ {f}_{l}^{( 1 )} \} and \{ {f}_{l}^{( 2 )} \}$$
where each
$${f}_{l}^{( \cdot )}$$
produces a feature map;
a sequence of Cross-Fusion Modules
$$\{ {D}_{θ}^{( l )} \}$$
is applied at each layer l, computing a partial difference; and
the difference signals Δₗ are propagated alongside or merged with the features in both branches for a next layer's computation, forming a hierarchically fused differential architecture.

5. The architecture of claim 4, wherein:
the feature map is given by:
$${Δ}_{l} = {𝒟}_{θ}^{( l )} ( {M}_{l}^{( 1 )} , {M}_{l}^{( 2 )} ) ;$$
the partial difference is given by:
$${Δ}_{l} = {𝒟}_{θ}^{( l )} ( {M}_{l}^{( 1 )} , {M}_{l}^{( 2 )} ) .$$

6. The architecture of claim 4, wherein a difference computation is interleaved with an feature extraction such that the Cross-Fusion Modules are not applied only at the final layer, but are distributed across the depth of the network.

7. The architecture of claim 6, wherein the architecture enables semantic enrichment of difference representations at multiple abstraction levels

8. The architecture of claim 4, wherein the difference signal at each layer l is determined via a learned function:
$${Δ}_{l} = σ ( {ℱ}_{{θ}_{l}} ( {M}_{l}^{( 1 )} , {M}_{l}^{( 2 )} ) ) ,$$
and is then:
fed forward to a next Cross-Fusion Module,
and/or used to modulate the processing of the next layer via additive or multiplicative fusion with the inputs:
$${M}_{l + 1}^{( 1 )} ← {M}_{l + 1}^{( 1 )} ⊕ {Δ}_{l} , {M}_{l + 1}^{( 2 )} ← {M}_{l + 1}^{( 2 )} ⊕ {Δ}_{l} ,$$
where ⊕ denotes element-wise addition or gated fusion.

9. The architecture of claim 4, wherein the architecture ensures that each stream is aware of how it differs from the other throughout the depth of the network.

10. The architecture of claim 4, wherein the outputs of the Cross-Fusion Modules are split into two paths, and each injected into a separate stream, such that both branches independently process the shared difference information.

11. The architecture of claim 10, wherein the architecture supports one or more of: asymmetric transformations, bidirectional modeling, forward and reverse difference estimation, and inter-branch interactions.

12. A computer-readable information storage media having stored thereon instructions, that when executed by computing resources, perform a method for learning the transformation between two instances of structured input data using a differential neural network, the method comprising:
receiving a first data input and a second data input, both mapped into high-dimensional latent spaces via a shared or separate feature extractor;
representing each input as a discrete latent manifold;
determining a learned difference representation using a series of parameterized Cross-Fusion Modules applied progressively at each layer l, and
using this representation to predict a target output corresponding to a measured or inferred transformation across the two input states.
